(19) United States
(12) Patent Application Publication
(10) Pub. No.: US 2025/0078853 A1
(43) Pub. Date: Mar. 6, 2025

(54) MACHINE LEARNING MODEL ARCHITECTURE FOR SPEECH ENHANCEMENT SYSTEM

(71) Applicant: Cypress Semiconductor Corporation, San Jose, CA (US)

(72) Inventors: Monisankha Pal, Irvine, CA (US); Arvind RAMANATHAN, Dublin, CA (US); Ted WADA, Irvine, CA (US); Ashutosh PANDEY, Irvine, CA (US)

(73) Assignee: Cypress Semiconductor Corporation, San Jose, CA (US)

(21) Appl. No.: 18/675,664

(22) Filed: May 28, 2024

Related U.S. Application Data
(60) Provisional application No. 63/536,034, filed on Aug. 31, 2023.

(51) Int. Cl. G10L 21/0208; G06N 3/0442; G06N 3/0455; G06N 3/0464

(52) U.S. Cl. CPC G10L 21/0208; G06N 3/0442; G06N 3/0455; G06N 3/0464; G10L 2021/02082

(57) ABSTRACT

Methods and systems for a machine learning model architecture for speech enhancement system. The disclosed machine learning model architecture includes, among other things, an encoder, a decoder, and a bottleneck disposed between the encoder and the decoder. The encoder includes a plurality of encoder layers, and the decoder includes a plurality of decoder layers. Each encoder layer is connected to a corresponding decoder layer via a skip connection. Each encoder layer includes a Res2Net and a squeeze-and-excitation (SE) block. The bottleneck includes a first gated recurrent unit (GRU) layers and a second GRU layer.

### RELATED APPLICATIONS

This application claims the benefit of U.S. Provisional Patent Application No. 63/536,034 filed Aug. 31, 2023, the entire contents of which are incorporated by reference herein.

### TECHNICAL FIELD

Aspects and implementations of the present disclosure relate to machine learning model architecture for speech enhancement system.

### BACKGROUND

Speech enhancement systems have become integral in improving the perceptual quality and intelligibility of speech waveforms contaminated by additive background noise and reverberation.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example speech enhancement system, in accordance with implementations of the present disclosure.

FIG. 2 is an exemplary illustration of a machine learning model architecture used for speech enhancement, in accordance with implementations of the present disclosure.

FIG. 3A and 3B is an exemplary illustration of an encoder of the machine learning model of FIG. 2, in accordance with implementations of the present disclosure.

FIG. 4 is an exemplary illustration of a Res2Net layer of an encoder layer of the encoder of FIG. 3, in accordance with implementations of the present disclosure.

FIG. 5 is an exemplary illustration of a squeeze-and-excitation (SE) layer of an encoder layer of the encoder of FIG. 3, in accordance with implementations of the present disclosure.

FIG. 6 is an exemplary illustration of a bottleneck of the machine learning model of FIG. 2, in accordance with implementations of the present disclosure.

FIG. 7 is an exemplary illustration of training the machine learning model of FIG. 2, in accordance with implementations of the present disclosure.

FIG. 8 depicts a flow diagram of an example method for processing a waveform using the speech enhancement system, in accordance with implementations of the present disclosure.

FIG. 9 is a block diagram illustrating an exemplary computer system, in accordance with implementations of the present disclosure.

### DETAILED DESCRIPTION

Aspects of the present disclosure relate to machine learning model architecture for speech enhancement system. Speech enhancement systems are typically designed to improve the quality and intelligibility of speech signals, especially in environments with noise or other forms of interference. Speech enhancement systems are crucial in various applications, for example in speech recognition, hearing aids, and modern telecommunication systems.

Traditional speech enhancement systems utilize one or more methods to achieve better noise reduction and speech quality. For example, some speech enhancement systems, such as a speech enhancement system using spectral subtraction in conjunction with Wiener filtering, produce estimation of the distribution or composition of the frequencies present in noise of the speech signal (e.g., noise spectra) and/or the adjustment to an amplitude of the speech signal (e.g., gain mask). Thus, the speech enhancement system multiplies the estimated gain mask with the noisy spectrum of the speech signal to produce the enhanced spectrum. Traditional speech enhancement systems operate under the assumption that the noise is stationary or slowly varying, such as constant background hum, fan noise, and slowly varying traffic noise. In real-world environments, noise is often non-stationary; it varies quickly over time. Non-stationary noise includes, for example, background conversations, doors slamming, cars honking, dogs barking, birds chirping, keyboard typing, etc. Thus, traditional speech enhancement systems tend to fail at reducing noise and improving speech quality. This is further complicated with low signal-to-noise-ratio (SNR) conditions in which the noise level is high compared to the speech level, making it difficult to distinguish between noise and speech, leading to less accurate estimation.

In recent years, machine learning and deep learning algorithms are increasingly used since they are more adept at handling non-stationary noise and preserving speech quality. Most notably, the implementation of deep neural networks (DNNs) in speech enhancement systems (e.g., DNN speech enhancement systems). DNN speech enhancement systems have significantly advanced the field, offering more robust performance than traditional speech enhancement systems in various noise conditions, including non-stationary noise and low SNR conditions. DNN speech enhancement systems are typically time-frequency based or waveform domain-based.

Time-frequency based DNN speech enhancement systems typically estimate one or more masks (e.g., ideal ratio mask, spectral magnitude mask, and/or usage of spectral features) that can be applied to the noisy speech spectrum. These masks selectively attenuates or amplifies different frequency components, aiming to suppress noise while preserving speech. However, time-frequency based DNN speech enhancement systems ignore (fails to manipulate) the phase component due to its complexity. Thereby resulting in less accurate estimation and/or enhancements.

Waveform domain-based DNN speech enhancement systems typically process and enhance the raw speech waveform to output a clean speech waveform. However, waveform domain-based DNN speech enhancement systems are typically computationally complex due to their reliance on DNNs with large model sizes and the need for intensive training. This complexity poses challenges for real-time processing, especially with resource-constrained devices.

Aspects and embodiments of the present disclosure address these and other limitations of the existing technology by providing a machine learning (ML) model for speech enhancement system. In some implementations, the machine learning model includes an encoder, bottleneck, and decoder with multiple skip connections that each directly connect an encoder layer of the encoder to a decoder layer of the decoder. In some embodiments, the number of encoder layers of the encoder are substantially equivalent to a number of decoder layers of the decoder. Each encoder layer of the encoder includes a residual network block, such as a Res2Net, and a squeeze-excitation (SE) block. The residual network block includes hierarchical residual like connection that enables multiple-size of receptive fields, resulting in multiple feature scales. The SE block adaptively re-calibrates channel-wise feature responses. The bottleneck includes a sequence of uni-directional gated recurrent unit (GRU) layers (e.g., a first GRU layer, and a second GRU layer).

During operation, the machine learning (ML) model receives a speech waveform (e.g., an original speech waveform or first speech waveform). The original speech waveform is forwarded to the encoder of the ML model. Each encoder layer of the encoder generates a latent output of the original speech waveform (e.g., feature maps). In particular, for example, a residual network block of a respective encoder layer of the encoder receives feature maps (or latent output of the previous encoder layer) and generates multi-scale feature maps with multiple sizes of receptive fields. The SE block of the respective encoder layer of the encoder receives the multi-scale feature maps. The SE block squeezes the multi-scale feature maps to a vector of average activation. The SE block generates, using the vector of average activation, a vector of scale values. The SE block recalibrates, using the vector of scale values, the multi-scale feature maps. The SE block combines the recalibrated multi-scale feature maps with the original multi-scale feature maps to generate enhanced feature maps. The encoder layer generates a latent representation of the enhanced feature maps (e.g., a latent output). Additionally, each encoder layer downsamples the input, while increasing the number of channels. The output of the last encoder layer of the encoder (e.g., a latent output) is forwarded to a bottleneck.

The bottleneck receives the output of the last encoder layer of the encoder (e.g., the latent output) and outputs a non-linear transformation of the output of the last encoder layer of the encoder. The output of the bottleneck is forwarded to the decoder.

Each decoder layer of decoder increases the dimensionality of an input (e.g., the output of the bottleneck or an output of a previous decoder layer) by upsampling and halving the number of channels. Each decoder layer further receives, via a skip connection which connected with a corresponding encoder layer, an output of the corresponding encoder layer. The output of the corresponding encoder layer, which includes detailed features, and the output of the bottleneck, which includes abstract features, assist each decoder layer in reconstructing a speech waveform. Additionally, each decoder layer upsamples the input, while decreasing the number of channels. Typically, the last decoder layer of the decoder results in a single channel that is used to reconstruct a speech waveform with the same dimension as the original speech waveform. The speech waveform reconstructed from the single channel represents a predicted speech waveform, substantially equivalent to an enhanced speech waveform (or a second speech waveform) associated with the original speech waveform (or first speech waveform).

During training, the ML model is optimized using a loss function calculated based on (i) a difference between a waveform of clean speech waveform of training data associated with an original speech waveform of training data and a waveform of an output of the ML model (e.g., enhanced speech waveform) associated with the original speech waveform of the training data, and (ii) a difference between a magnitude spectrogram of the clean speech waveform of the training data associated with original speech waveform of the training data and a magnitude spectrogram of the output of the ML model associated with the original speech waveform of the training data.

Aspects of the present disclosure overcome these deficiencies and others by reducing a computational complexity of the machine learning model used to predict enhanced speech waveform from an original speech waveform, while simultaneously improving the performance of the prediction.

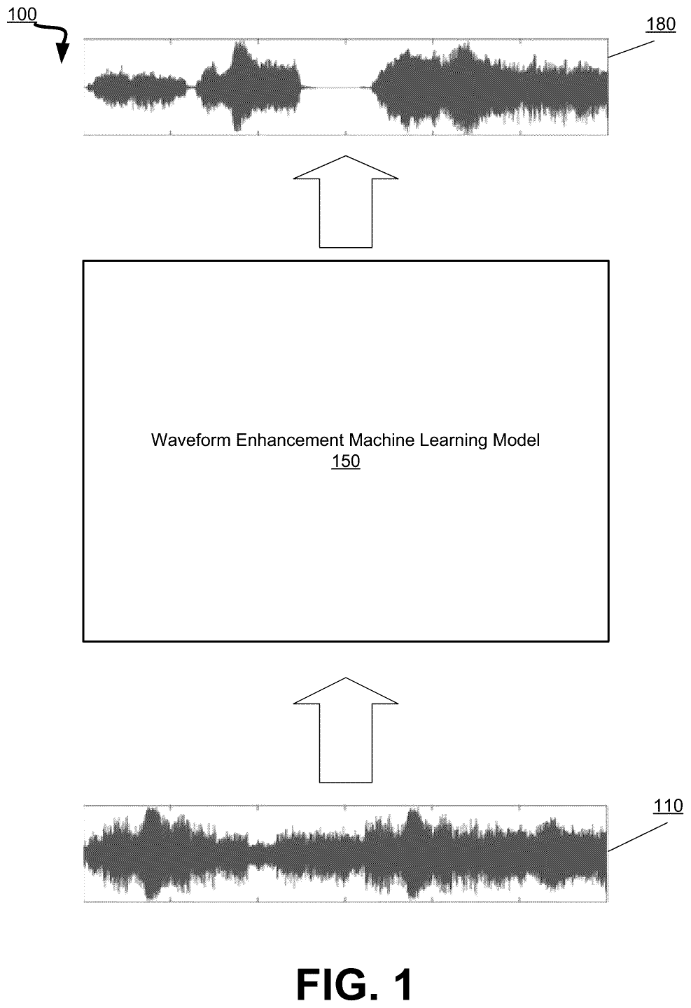

FIG. 1 illustrates an example speech enhancement system 100, in accordance with implementations of the present disclosure. speech enhancement system 100 includes a waveform enhancement machine learning (ML) model 150 (also referred to as “ML model” herein) that can receive an original speech waveform 110 and output an enhanced speech waveform 180. In some embodiments, original speech waveform 110, represented as x_{noisy}, may be composed of clean speech, represented as x, that may be corrupted by a convolutive room impulse response (RIR) (e.g., h) and/or additive background noise (e.g., xₙₒᵢₛₑ). Accordingly, original speech waveform 110 (e.g., x_{noisy}) can be expressed mathematically by: Equation (1): x_{noisy}=x*h+xₙₒᵢₛₑ.

ML model 150 operates as a denoiser function that predict a speech waveform (e.g., x_{pred}) by removing noise (e.g., xₙₒᵢₛₑ) from an original speech waveform (e.g., x_{noisy}). The predicted speech waveform (e.g., x_{pred}) is substantially equivalent to an enhanced speech waveform (e.g., x). ML model 150 can be expressed mathematically by: Equation (2): x_{pred}=f(x_{noisy})≈x.

ML model 150 may be deployed to an edge device to provide speech enhancement functionality. The edge device may be a computing device of modest processing and memory capabilities and can have access to local data (e.g., via an Internet-of-Things, or IoT, network) and to a cloud service. Computing device may be implemented on (or shared among) any number of computing devices and/or on a cloud. Computing device may be a desktop computer, a laptop computer, a smartphone, a tablet computer, a server, a computing device that accesses a remote server, a computing device that utilizes a virtualized computing environment, a gaming console, a wearable computer, a smart TV, and so on. Computing device may have any number of central processing units (CPUs) and graphical processing units (GPUs), including virtual CPUs and/or virtual GPUs, or any other suitable processing devices. Computing device may further have any number of memory devices, network controllers, peripheral devices, and the like. Peripheral devices may include various sensing devices, photographic cameras, video cameras, microphones, scanners, or any other devices for data intake.

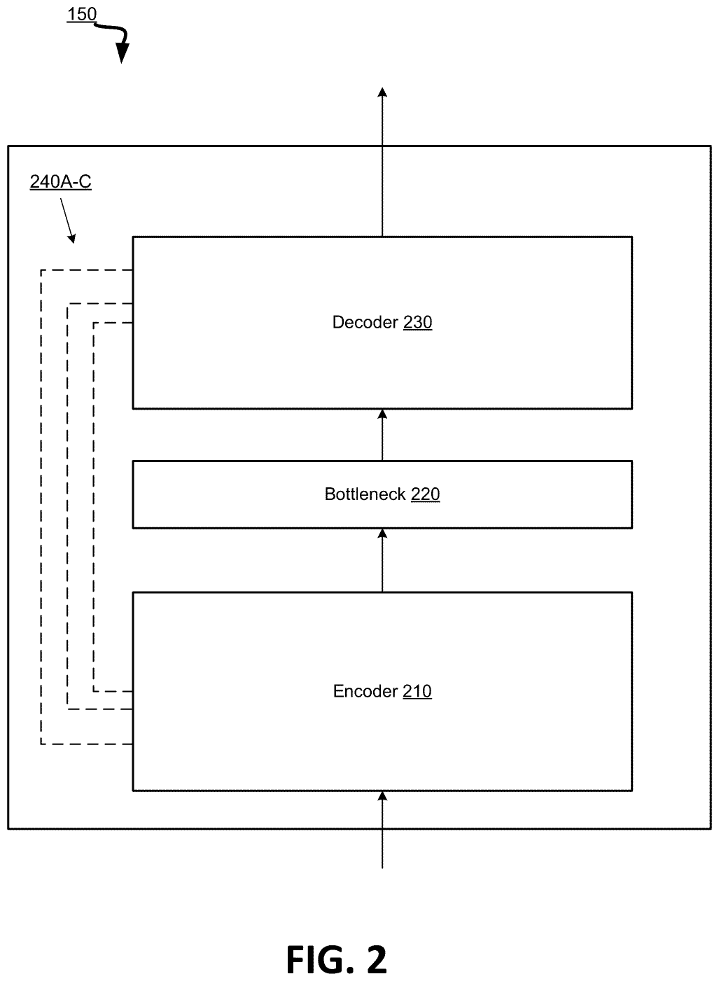

FIG. 2 is an exemplary illustration of the architecture of ML model 150 of FIG. 1, in accordance with implementations of the present disclosure. ML model 150 may include an encoder 210, a bottleneck 220 and, a decoder 230. The bottleneck 220 is disposed between the encoder 210 and the decoder 230. ML model 150 may further include skip connection 240A-C. Each skip connection of skip connection 240A-C directly connects, in reverse order, an encoder layer of the encoder 210 to a decoder layer of the decoder 230. For example, a first encoder layer of the encoder 210 is directly connected via a first skip connection (e.g., skip connection 240A) to a last decoder layer of the decoder 230.

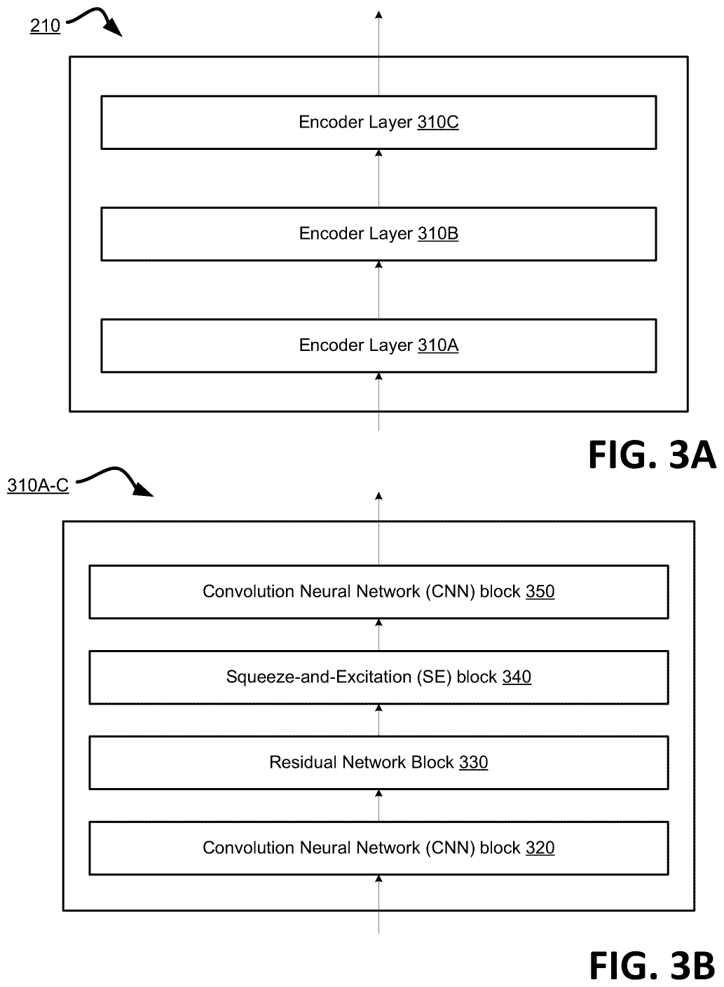

With quick reference to FIG. 3A, encoder 210 receives original speech waveform 110 and processes the original speech waveform 110 through a plurality of encoder layer (e.g., encoder layers 310A-C of FIG. 3B) to generate a latent output. Each encoder layer can be expressed mathematically by: z=E(x_{noisy}), where E represents an encoder layer of the encoder 210, x_{noisy} represents the original speech waveform, and z represents a latent output. The first encoder layer of the encoder 210 receives the original speech waveform (x_{noisy}) and generates a latent output z. Each subsequent encoder layer, receives as input the latent output of the previous encoder layer having 2ⁱ⁻²H channels and generates a latent output represented as min(2ⁱ⁻¹H, Cm) channels, wherein H refers to the number of hidden channels of the first encoder layer, Cm refers to a maximum allowed channel dimension, and i refers to the i^{th} encoder layer of the encoder layers of the encoder 310A-C. In other words, each encoder layer downsamples the data of the input from the previous encoder layer while increasing the number of channels.

With reference to FIG. 3B, each encoder layer (e.g., encoder layers 310A-C) includes a convolutional neural network (CNN) block 320, a residual network block 330, a squeeze-and-excitation (SE) block 340, and a CNN block 350.

The CNN block 320 includes a strided 1-D convolution (e.g., conv1D) layer, a rectified linear unit (ReLU) activation function, and a batch normalization (BN). The strided conv1D layer refers to a set of learnable filters (or kernels) that slide over a 1-dimensional input data based on a stride. In some embodiments, the strided conv1D layer is casual, which indicates that the output at any given point in the sequence only depends on the input. The stride refers to the number of positions the filter moves over the input data in each step. A stride greater than 1 leads to downsampling, which effectively reduces the length of the output sequence compared to the input. In some embodiments, the stride (of 2) which indicates that it is down sampled by 2 in each encoder layer.

Each filter convolves across the input data to produce a transformed version of the data. The number of filters determines the number of generate feature maps, also known as output channels. In other words, each filter processes all input channels simultaneously, producing a single feature map (or output channel). Therefore, an increased number of filters directly results in an increased number of output channels (or feature maps). The strided conv1D layer down-samples the input in length and increases the number of output channels. For example, each encoder layer inputs 2ⁱ⁻²H channels and outputs min(2ⁱ⁻¹H, Cm) channels, wherein H refers to the number of hidden channels of the first encoder layer, Cm refers to a maximum allowed channel dimension, and i refers to the i^{th} encoder layer of the one or more encoder layers 310A-C. In some embodiment, Cm may be set to a predefined number (e.g., 768).

ReLU activation function when applied to the feature maps (e.g., the output of the strided 1-D convolution) introduces non-linearity to enhance the representation of important patterns and characteristics within the feature maps. BN normalizes the feature maps by adjusting its mean and variance. BN effectively stabilizes and accelerates the learning process and ensures consistent feature scale for more effective training of subsequent layers.

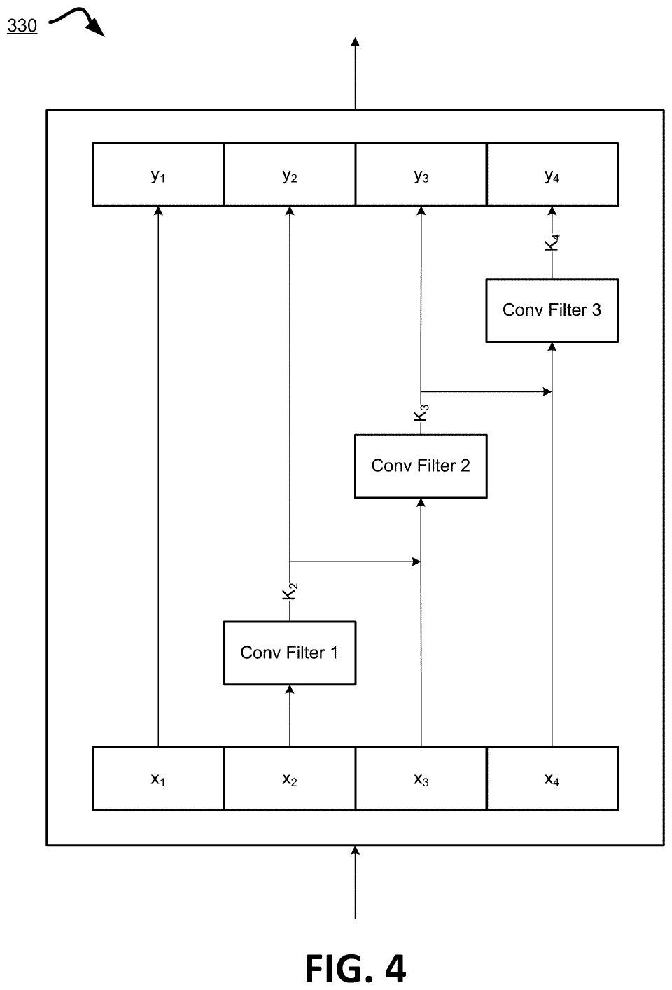

The residual network block 330, such as a Res2Net, receives an output of the CNN block 320 (e.g., feature maps). The residual network block 330 enables the presence of multiple sizes of receptive fields, thereby leading to the extraction of features at multiple scales. With quick reference to FIG. 4, the residual network block 330 evenly divides the feature maps by channel dimension into a predetermined number of subsets, for example, x₁, x₂, x₃, x₄. In other words, the predetermined number of subsets may be represented as s, where each subset is represented as xᵢ, and, where i∈{1, 2, . . . , s}. Each subset, excluding the first subset (e.g., x₁), has a corresponding convolution filter represented as Kᵢ (e.g., K₂, K₃, K₄). Each convolution filter is a matrix of weights configured to extract features across a range of scales to increase the number of available receptive fields for an input. For example, each convolution filter may be a 3×3 convolution filter that totals 9 weights (or learnable parameter), which can be adjusted during training.

The residual network block 330 generates an output, represented as yᵢ, for each subset. The output can be expressed mathematically by:

$${y}_{i} = \{ \begin{matrix}{x}_{i} , & x = 1 \\ {K}_{i} ( {x}_{i} ) , & x = 2 \\ {K}_{i} ( {x}_{i} + {y}_{i - 1} ) , & x > 2\end{matrix} \qquad Equation ( 4 )$$

where i=1, the residual network block 330 outputs xᵢ as yᵢ (i.e., y₁=x₁), where i=2, the residual network block 330 processes xᵢ through convolution filter Kᵢ and outputs yᵢ (i.e., y₂=K₂(x₂)), and where i>2, the residual network block 330 processes xᵢ and yᵢ₋₁ through convolution filter Kᵢ and outputs yᵢ (i.e., y₃=K₃(x₃+y₂)). As a result, early subsets (e.g., y₁, y₂) have smaller receptive fields, capturing finer details, while later subsets (e.g., y₃, y₄, . . . ) effectively have larger receptive fields due to the combination of inputs. Thus, the larger receptive fields capture broader contextual information. Depending on the embodiment, context information for the output of each subset (e.g., y₁, y₂, y₃, y₄) may be increased using a combination of a dilated convolution with a predetermined dilation factor (e.g., 2), a ReLU activation function, and a BN.

The residual network block 330 may concatenate the outputs of the residual network block 330 (e.g., y₁, y₂, y₃, y₄) along the channel dimension. This results in new feature maps (e.g., feature maps y) with a spatial resolution that is the same as the inputted feature maps, but with a significantly higher number of channels. Feature maps y captures a wider range of information and allows the network to learn more complex features. The residual network block 330 forwards feature maps y to the SE block 340.

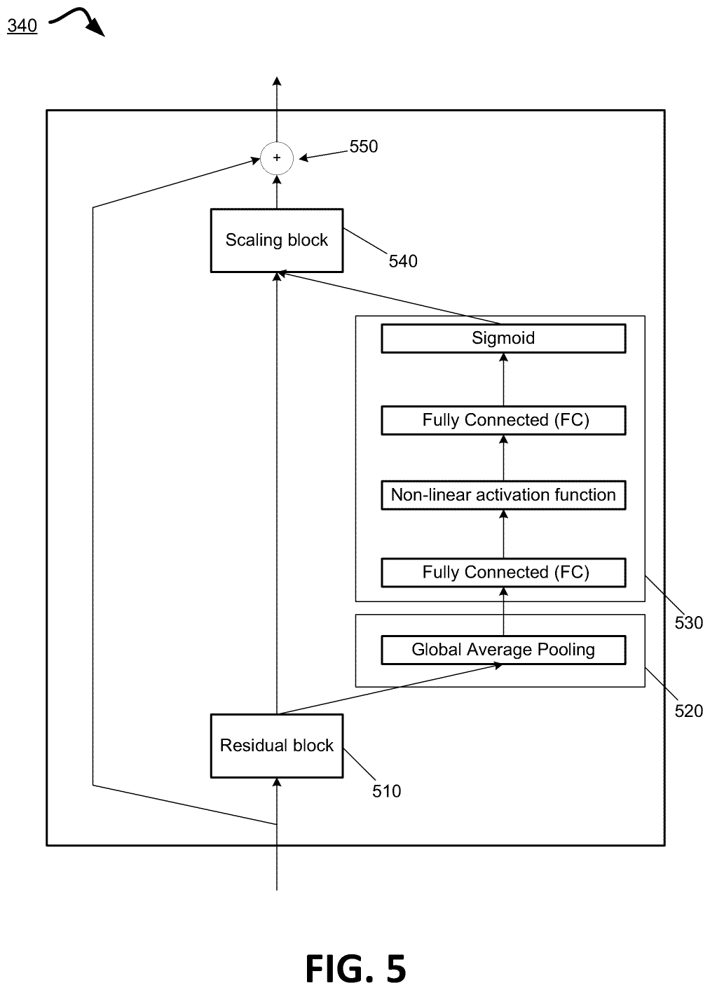

With reference to FIG. 5, SE block 340 (of FIG. 3) receives feature maps y from the residual network block 330. The SE block 340 passes the feature maps y to residual network block 330 to enhance feature map y (e.g., enhanced feature maps y′) by assigning adaptive weights to each channel. The SE block 340 includes a residual block 510, a squeeze block 520, an excitation block 530, a scaling block 540, and a residual connection 550.

The residual block 510 receives the feature maps y and extracts and/or transform features, resulting in a modified feature maps y. The modified feature maps y is forwarded the squeeze block 520. The squeeze block 520 squeezes each channel to a single numeric value using global average pooling (GAP) layer. The GAP layer can be expressed mathematically by:

$${z}_{C} = \frac{1}{T} {\sum }_{t = 1}^{T} {y}_{t} \qquad Equation ( 5 )$$

where, z_{c} represents an output value for channel c of the pooled feature maps (e.g., pooling of modified feature maps y), yₜ represents a value at t which represents a row and column of channel c in the modified feature maps y, and T represents the spatial dimensions (height and width) of the modified feature maps y. Accordingly, for each channel c of the modified feature maps y, the GAP layer iterates through all elements t, GAP layer sums the values of all elements in the channel, divides the sum by the total number of elements in the channel (T), and the resulting value z_{c} represents the average activation for channel c in the pooled feature maps. The z_{c} across all channels together form a vector ž capturing a representation of the global information in the inputted feature map.

Vector ž is forwarded to the excitation block 530, which calculates weights for each channel, resulting in a vector of scale values s, using a first fully connected (FC) layer, a non-linear activation function, a second FC layer, and a sigmoid activation. The excitation block 530 can be expressed mathematically by: Equation (6): s=σ(W2ƒ(W1*ž+b1)+b2).

In view of equation (6), the first FC layer, characterized by the weight matrix W₁, reduces the dimensionality of vector ž. The non-linear activation function, represented as ƒ( ), is applied to the output of the first FC layer to introduce non-linearity. The second FC layer, characterized by the weight matrix W₁, receives the output of the non-linear activation function and increases the dimensionality back to its original size. The sigmoid activation, represented as σ, receives the output of the second FC layer and transforms each element of the output of the second FC layer to a value between 0 and 1. The output of the sigmoid activation, represented as s, as noted above s refers a vector of scale values, one for each channel. The vector of scale values contains channel weights which are used to adaptively recalibrate the feature maps by scaling each channel based on learned importance.

The vector of scale values (e.g., vector s) are forwarded to the scaling block 540. In addition to the scaling block 540 receiving vector s, the scaling block 540 receives the modified feature maps y. The scaling block 540 recalibrates the modified feature maps y by performing channel-wise multiplication on the modified feature maps y with the vector of scale values (e.g., vector s). Thus, the scaling block 540 adaptively emphasizing or suppressing different features in the modified feature maps y. The scaling block 540 (or channel-wise multiplication) can be expressed mathematically by: Equation (7): z_{c}=s_{c}*y_{c} where, y_{c} is the c-th channel of the modified feature maps y, s_{c} is the c-th scale value of s, z_{c} is the recalibrated c-th channel of the modified feature maps y. In other words, channel-wise multiplication is an element-wise operation. For each channel in the modified feature maps y, every element of that channel is multiplied by a single scalar value (the channel-specific weight). This operation scales the intensity of the features in each channel. Channels with higher weights will have their features amplified (or emphasized), while those with lower weights will have their features attenuated (or suppressed). Accordingly, the output of the scaling block 540 are recalibrated feature maps.

The recalibrated feature maps are forwarded to the residual connection 550. In addition to the residual connection 550 receiving recalibrated feature maps, the residual connection 550 receives the feature maps y. The residual connection 550, represented as “+” sign, adds the feature maps y with the recalibrated feature maps to generate the enhanced feature map (e.g., enhanced feature maps y′). The enhanced feature map (e.g., enhanced feature maps y′) is an enriched feature representation that combines original and learned features. The SE block 340 forwards the output of the SE block 340 (e.g., enhanced feature maps y′) to the CNN block 350.

The CNN block 350 receives enhanced feature maps y′. The CNN block 350 includes a convolutional layer (e.g., 1×1 convolutional layer) and a gated linear unit (GLU). The convolutional layer may be used to double the number of channels in enhanced feature maps y′. The GLU may be used to halve the number of channels in enhanced feature maps y′ based on the number of filters. The GLU is an activation function that combines the outputs of two linear units using a gating mechanism, thereby allowing the network to selectively focus on relevant information. The output of the CNN block 350 is a latent representation of enhanced feature maps y′ (e.g., latent output z). Latent representation refers to a learned abstract representation of enhanced feature maps y′ that captures essential information while typically being in a more compressed or simplified form.

With reference to FIG. 3A, the initial encoder layer (e.g., encoder layer 310A) receives an original speech waveform 110 of FIG. 1. The initial encoder layer generates, from the original speech waveform 110, a latent output of the original speech waveform 110 (e.g., an initial latent output). The initial latent output encapsulates certain aspects of the original speech waveform 110. The initial latent output is then fed into a subsequent encoder layer (e.g., encoder layer 310B). The subsequent encoder layer further processes the initial latent output to generate a latent output of the initial latent output (e.g., a subsequent latent output) which potentially extracts more refined or higher-level features. This, in some embodiments, is accomplished by downsampling a previous latent output (e.g., the initial latent output) in length and increasing the number of channels of the previous latent output. In other words, each subsequent encoder layer (e.g., encoder layer 310B and encoder layer 310C) receive a latent output of the previous encoder layer (e.g., encoder layer 310A and encoder layer 310B, respectively). The subsequent encoder layer processes the latent output of the previous encoder layer to generate a subsequent latent output which encapsulates certain aspects of the latent output of the previous encoder layer with more refined or higher-level features. This is repeated until the last encoder layer (e.g., encoder layer 310C) outputs a final latent output. Encoder 210 forwards the final latent output z to bottleneck 220.

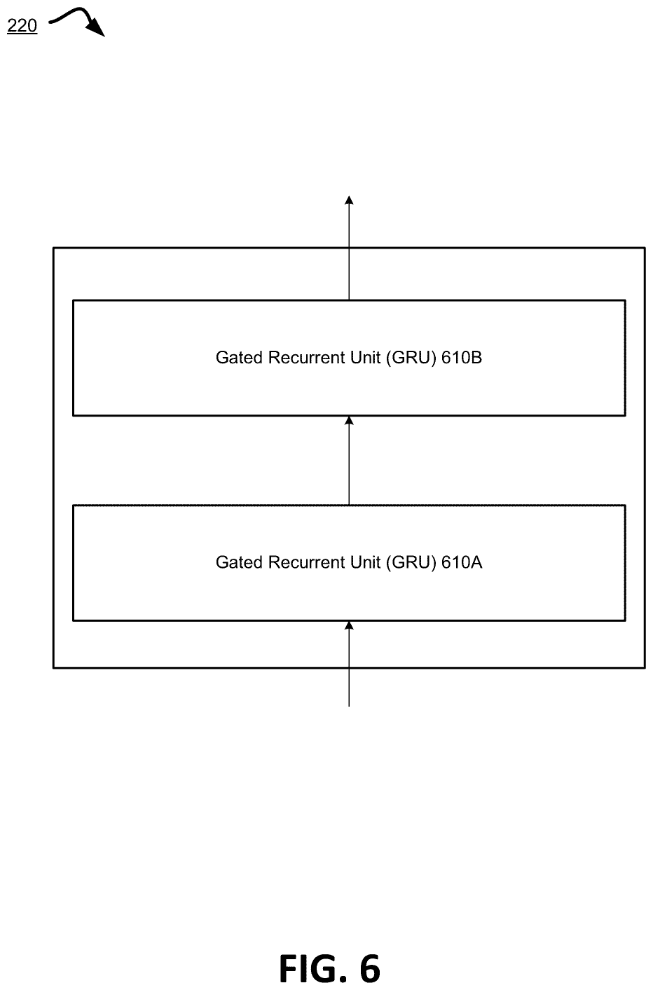

Bottleneck 220 receives the final latent output z and outputs a non-linear transformation of the final latent output z (e.g., latent output ž). In some embodiments, the final latent output z is the same size as the latent output ž. With reference to FIG. 6, the bottleneck 220 is a sequence modeling network that includes a first gated recurrent unit (GRU) layer 610A, a second GRU layer 610B. Each of the GRU layers (e.g., GRU layer 610A and GRU layer 610B) is a uni-directional GRU, which is a type of recurrent neural network (RNN), used for processing sequential data in one direction, from the beginning to the end of the sequence. Each of the GRU layers may include hidden units, also referred to as individual neurons, which are positioned between the input and output layers. In some embodiments, the number of hidden units may be min(2^{L-1}H, Cm) hidden units, where L refers to the number of encoder layers in encoder 210.

Each of the GRU layers can be expressed mathematically by: Equation (8): ž=GRU(z) where, GRU refers to a GRU layer (e.g., GRU layer 610A and GRU layer 610B), ž is the non-linear transformation of the inputted latent output z. Accordingly, GRU layer 610A receives the inputted latent output z, received from encoder 210, and generates a non-linear transformation of the latent output z (e.g., the latent output ž). GRU layer 610A forwards the latent output ž to GRU layer 610B. GRU layer 610B receives the inputted latent output z (e.g., the latent output ž received from GRU layer 610A) and generates a non-linear transformation of the inputted latent output (e.g., the latent output ž). In other words, each GRU layer (e.g., GRU layer 610A and GRU layer 610B) performs non-linear transformation on an input. It should be noted that other RNNs may be considered, one or more of the GRU layers may be replaced by a long short-term memory (LSTM), bi-directional LSTM with multiple self-attention layers, etc. The latent output ž is forwarded to decoder 230.

Decoder 230 produces a predicted speech waveform (e.g., x_{pred}) associated with the original speech waveform (e.g., x_{noisy}) by processing the latent output ž through a plurality of decoder layers. In some embodiment, the number of decoder layers of decoder 230 matches the number of encoder layers of encoder 210. Decoder 230 can be expressed mathematically by:

$$\hat{x} = D ( {z}^{⋁} ) \qquad Equation ( 9 )$$

where, D refers to decoder 230 including a plurality of decoder layers, ž is latent output received from the bottleneck 220, and x corresponds to enhanced speech waveform 180. Each decoder layer of decoder 230 includes a convolutional layer (e.g., 1×1 convolutional layer), a gated linear unit (GLU), and a transposed ID convolution. The convolutional layer may be used to double the number of channels. The GLU may be used to halve the number of channels. The transposed 1D convolution, also known as a fractionally-strided convolution or deconvolution, is a type of convolutional operation used to increase the dimensionality by upsampling and halving the number of channels. Additionally, as noted above, the skip connection which connects a respective decoder layer to a corresponding encoder layer of encoder 210 provides the respective decoder an output of the corresponding encoder layer. Thus, the latent output from the corresponding encoder layer (i.e., detailed features) and the latent output received from encoder 210 (i.e., abstract features) assist the decoder layer in reconstructing the speech waveform. Typically, the last decoder layer of the decoder 230 results in a single channel that is used to reconstruct a speech waveform with the same dimension as the original speech waveform.

For example, the initial decoder layer receives the latent output from encoder 210. In addition, the initial decoder layer receives the latent output from a corresponding encoder layer of encoder 210. The initial decoder layer reconstructs a speech waveform. Which, in some embodiments, is accomplished by upsampling and decreasing the number of channels. The speech waveform is then fed into a subsequent decoder layer. The subsequent decoder layer further reconstructs a subsequent speech waveform. As noted above, may be accomplished by upsampling and decreasing the number of channels. The subsequent decoder layer uses the speech waveform received from the initial decoder layer and a latent output from a corresponding encoder layer of encoder 210 to generate the subsequent speech waveform. In other words, each subsequent decoder layer receive a speech waveform from the previous decoder layer and latent output from a corresponding encoder layer. The subsequent decoder layer reconstructs a subsequent speech waveform. This is repeated until the last decoder layer which outputs a speech waveform reconstructed from a single channel with the same dimension as the original speech waveform 110 (e.g., x_{noisy}). The speech waveform reconstructed from a single channel represents a predicted speech waveform (e.g., x_{pred}) associated with the original speech waveform 110 (e.g., x_{noisy}). As noted above, the predicted speech waveform (e.g., x_{pred}) is substantially equivalent to enhanced speech waveform 180 (e.g., x).

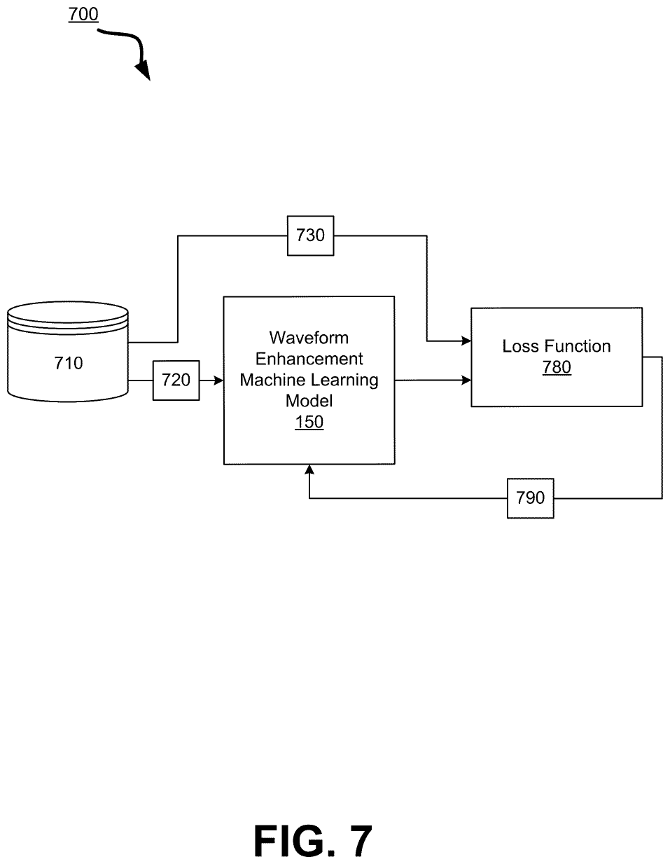

FIG. 7 is an exemplary illustration of a system 700 of training ML model 150, in accordance with implementations of the present disclosure. System 700 includes a dataset 710, ML model 150, and loss function 780.

In one embodiment, dataset 710 includes a collection of clean speech recordings from various speakers (e.g., ˜40 speakers) with diverse accents and speaking styles and a collection of noisy speech recordings obtained by adding various types of noise (e.g., babble, car noise, street noise) at different signal-to-noise ratios (SNRs). Training set 720 includes a plurality of utterances (e.g., ˜12,000) from multiple speakers (e.g., ˜30 speakers). Each utterance of the training set 720 includes clean utterances mixed with background noise with various different noise types taken from dataset 710 (e.g., ˜8 different noise types) and artificial noise types at various SNRs (e.g., 4 different SNRs). Testing set 730 incudes a plurality of utterances (e.g., ˜1,000) from multiple unseen speakers (e.g., ˜2). Each utterance of the testing set 730 are mixed with background noise with various different noise types taken from dataset 710 (e.g., ˜5 different noise types) and at various SNRs (e.g., 4 different SNRs). In some embodiments, the various SNRs used for the training set 720 is different from the various SNRs used for the testing set 730. In some embodiments, the various SNRs used for the training set 720 are the same with the various SNRs used for the testing set 730.

In another embodiment, dataset 710 includes a collection of audio clips from a plurality of speakers (e.g., ˜10,000 speakers) with a predetermined sampling frequency (e.g., 16 kHz). The clean set includes a predetermined amount of clean speech (e.g., ˜500 hours of clean speeches). The noise set includes a predetermined amount of noise (e.g., ˜180 hours) from various categories of noise (e.g., 150 noise classes). Training set 720 includes a plurality of clean-noise pairs (e.g., 500 hours of clean and noisy speech pairs) at various SNR levels (e.g., 31 SNR levels between −5 and 25 dB) with a predetermined silence length (e.g., 0.2 seconds) of each clean speech waveform. Testing set 730 includes a plurality of artificial (or synthetic) clean-noise pairs (e.g., 150 pairs) with and without reverb.

During training of ML model 150, each training data pair (x_{noisy}, x) of training set 720 is randomly cropped into a clip of predetermined length (e.g., T-second clip). Data augmentation, such as shuffling the noises within a batch, removing a fraction of frequency uniformly, adding decaying echoes of clean speech and noise to, may be applied to the cropped clip. Each training data of training set 720 is forwarded to ML model 150 to output an enhanced speech waveform x. The enhanced speech waveform x is forwarded to loss function 780. A clean speech waveform x of testing set 730 is forwarded to loss function 780. Loss function 780 receives enhanced speech waveform x and clean speech waveform x.

Loss function 780 is used for optimization of ML model 150. Loss function 780 incorporates L1 distance loss over the waveform and multi-resolution short-time Fourier transform (MRSTFT) loss over the magnitude spectrogram. Both losses are computed between the clean speech waveform x and the enhanced speech waveform x. MRSTFT loss is defined as a sum of the spectral convergence (sc) loss and magnitude (mag) loss. MRSTFT loss referred to as L_{MRSTFT} can be expressed mathematically by:

$${L}_{M R S T F T} ( x , \hat{x} ) = {\sum }_{i = 1}^{M} {L}_{s c}^{( i )} ( x , \hat{x} ) + {L}_{m a g}^{( i )} ( x , \hat{x} ) = {\sum }_{i = 1}^{M} \frac{{‖ s ( x ; {ϕ}_{i} ) - s ( \hat{x} ; {ϕ}_{i} ) ‖}_{F}}{{‖ s ( x ; {ϕ}_{i} ) ‖}_{F}} + \frac{1}{T} {‖ log \frac{s ( x ; {ϕ}_{i} )}{s ( \hat{x} ; {ϕ}_{i} )} ‖}_{1} \qquad Equation ( 10 )$$

where S(x; ϕᵢ)=|STFT(x)| and refers to the linear-scale magnitude spectrogram of x, S(\hat{x}; ϕᵢ)=|STFT(\hat{x})| refers to the linear-scale magnitude spectrogram of \hat{x}, ϕᵢ represents STFT hyper-parameters at i^{th} resolution, ∥ ∥_{F} and ∥ ∥₁ refers to the Frobenius and L1 norm respectively, and M refers to the total number of resolutions. STFT hyper-parameters includes, for example, a number of FFT bins, hop sizes, window lengths, etc. The number of FFT bins, for example, may be ∈{512, 1024, 2048}. The hop sizes, for example, may be ∈{50, 120, 240}. The window lengths, for example, may be ∈{240, 600, 1200}.

Given the MRSTFT loss, the resulting loss function 780 can be expressed mathematically by

$$L = ‖ x - \hat{x} ‖ 1 + \frac{1}{2} {L}_{M R S T F T} ( x , \hat{x} ) . \qquad Equation ( 11 )$$

Loss function 780 is used for model optimization. In particular, the result of loss function 780 represented as L (e.g., result 790) is fed back into ML model 150 and a gradient with respect to each parameter is calculated. Additional operations, such as Adam optimizer with momentum, may be performed on the gradients to further optimize the ML model. The Adam optimizer with momentum, also known as AMSGrad, adaptively adjusts the learning rate for each parameter based on their individual gradients and past squared gradients, and accumulates past gradients to build up momentum in the direction of descent. Additionally, a linear warmup with cosine annealing learning rate may be used during training. Simply, the loss function 780 in conjunction with other optimization methods adjusts the internal parameters (weights and biases) of the ML model 150 to minimize the overall loss. The processes of prediction by the ML model 150, loss calculation by the loss function 780, and parameter adjustments is repeated through various iterations over the training data.

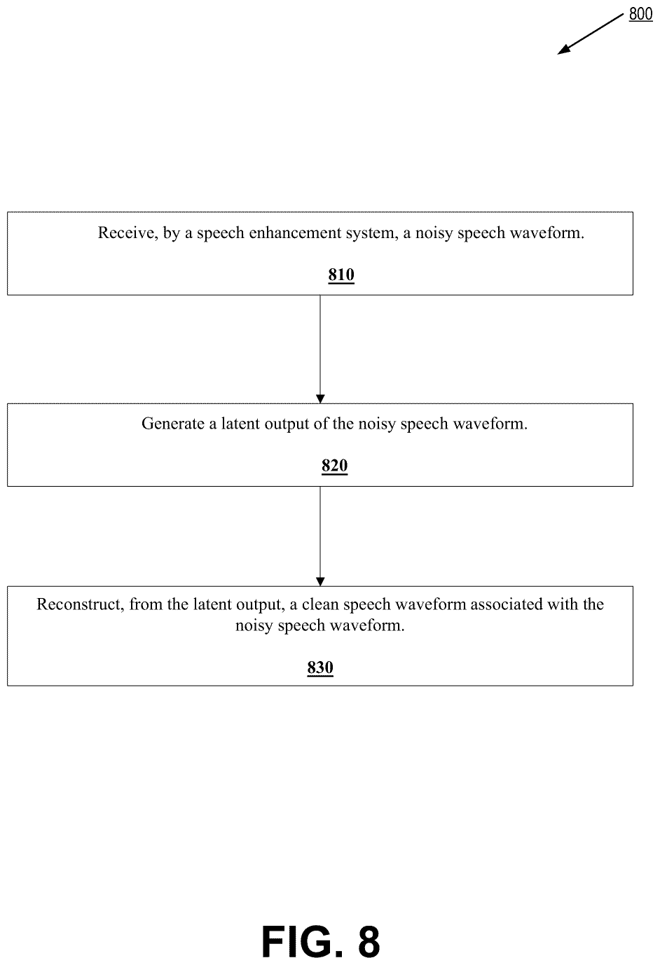

FIG. 8 depicts a flow diagram of an example method 800 for processing a waveform using the speech enhancement system, in accordance with implementations of the present disclosure. Method 800 can be performed by processing logic that can include hardware (circuitry, dedicated logic, etc.), software (e.g., instructions run on a processing device), or a combination thereof. In one implementation, some, or all of the operations of method 800 can be performed by ML model 150 of FIG. 1, as described above.

At block 810, processing logic receives, by the speech enhancement system, an original speech waveform. As previously described, original speech waveform is composed of clean speech that may be corrupted by convolutive RIR and/or additive background noise. The speech enhancement system operates as a denoiser function that predict a speech waveform, which is substantially equivalent to an enhanced speech waveform.

At block 820, processing logic generates a latent output of the original speech waveform. As previously described, an encoder of the speech enhancement system is used to generate the latent output of the original speech waveform. In particular, each encoder layer of the encoder includes a residual network block and a SE block. The residual network block of a respective encoder layer receives feature maps (or latent output of the previous encoder layer) and generates multi-scale feature maps with multiple sizes of receptive fields.

The SE block of a respective encoder layer receives the multi-scale feature maps from the residual network block. The SE block squeezes the multi-scale feature maps to a vector of average activation. The SE block generates, using the vector of average activation, a vector of scale values. The SE block recalibrates, using the vector of scale values, the multi-scale feature maps. The SE block combines the recalibrated multi-scale feature maps with the original multi-scale feature maps to generate enhanced feature maps. The encoder layer generates a latent representation of the enhanced feature maps (e.g., a latent output). The output of the last encoder layer represents the latent output of the original speech waveform.

In some embodiments, a bottleneck of the speech enhancement system receives the latent output of the original speech waveform and outputs a non-linear transformation of the latent output of the original speech waveform which may be forwarded to the decoder.

At block 830, processing logic reconstructs, from the latent output, an enhanced speech waveform associated with the original speech waveform. The latent output refers to the latent output of the original speech waveform. As previously described, each decoder layer of decoder increases the dimensionality of an input (e.g., the latent output or an output of a previous decoder layer) by upsampling and halving the number of channels. Each decoder layer further receives, via a skip connection which connected with a corresponding encoder layer, an output of the corresponding encoder layer. The output of the corresponding encoder layer, which includes detailed features, and the latent output, which includes abstract features, assist each decoder layer in reconstructing a speech waveform. Additionally, each decoder layer upsamples the input, while decreasing the number of channels. The output of the last decoder layer of the decoder is a speech waveform reconstructed from a single channel (e.g., an enhanced speech waveform). In some embodiment, the speech waveform outputted by the last decoder layer is the same dimension as the original speech waveform.

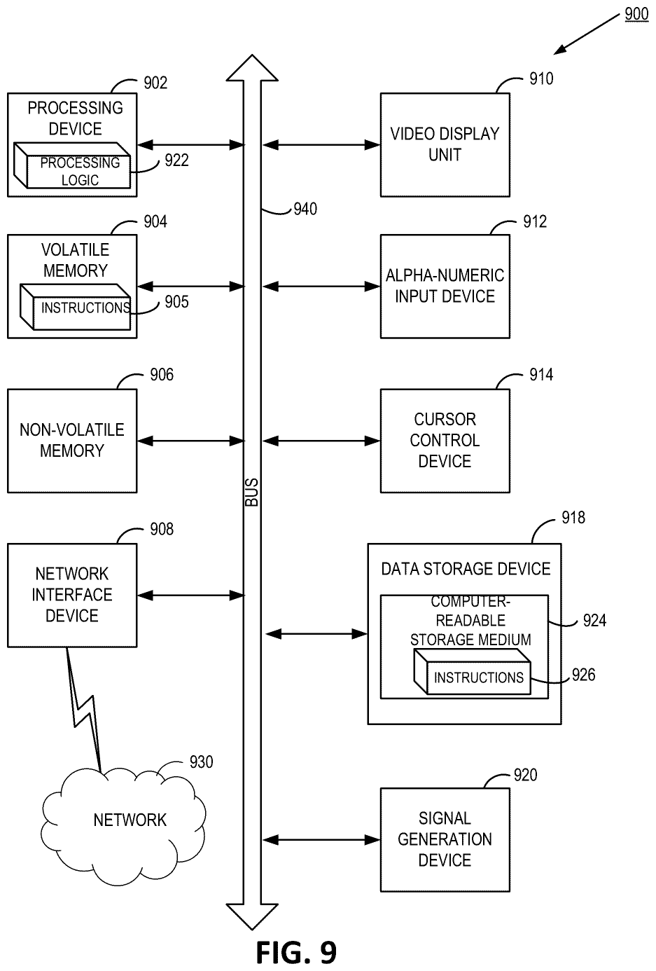

FIG. 9 is a block diagram illustrating an exemplary computer system 900, in accordance with implementations of the present disclosure. The computer system 900 can correspond to an edge device in which ML model 150, described with respect to FIG. 1, is deployed. Computer system 900 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processing device (processor) 902, a main memory 904 (e.g., read-only memory (ROM), flash memory, dynamic random access memory (DRAM) such as synchronous DRAM (SDRAM), double data rate (DDR SDRAM), or DRAM (RDRAM), etc.), a static memory 906 (e.g., flash memory, static random access memory (SRAM), etc.), and a data storage device 918, which communicate with each other via a bus 940.

Processor (processing device) 902 represents one or more general-purpose processing devices such as a microprocessor, central processing unit, or the like. More particularly, the processor 902 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 902 can also be one or more special-purpose processing devices such as an application specific integrated circuit (ASIC), a field programmable gate array (FPGA), a digital signal processor (DSP), network processor, or the like. The processor 902 can include processing logic 922 used to perform the operations discussed herein. The processor 902 is configured to execute instructions 905 for performing the operations discussed herein.

The computer system 900 can further include a network interface device 908. The computer system 900 also can include a video display unit 910 (e.g., a liquid crystal display (LCD) or a cathode ray tube (CRT)), an input device 912 (e.g., a keyboard, and alphanumeric keyboard, a motion sensing input device, touch screen), a cursor control device 914 (e.g., a mouse), and a signal generation device 920 (e.g., a speaker).

The data storage device 918 can include a non-transitory machine-readable storage medium 924 (also computer-readable storage medium) on which is stored one or more sets of instructions 926 embodying any one or more of the methodologies or functions described herein. The instructions can also reside, completely or at least partially, within the main memory 904 and/or within the processor 902 during execution thereof by the computer system 900, the main memory 904 and the processor 902 also constituting machine-readable storage media. The instructions can further be transmitted or received over a network 930 via the network interface device 908.

While the computer-readable storage medium 924 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “comprises,” “comprising,” “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “block,” “layer,” “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution, and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving a first speech waveform;
processing an input based on the first speech waveform using a trained machine learning model to generate a second speech waveform, wherein the trained machine learning model comprises:
an encoder, wherein the encoder comprises a plurality of encoder layers, each encoder layer comprising:
receiving, by a residual network block of a respective encoder layer, as input one of: a first speech waveform or multi-scale feature maps outputted from a previous encoder layer of the plurality of encoder layers; and
generating, based on the input, multi-scale feature maps of the respective encoder layer.

2. The method of claim 1, wherein the residual network block is a Res2Net.

3. The method of claim 1, wherein each encoder layer further comprising:
receiving, by a squeeze-and-excitation (SE) block of the respective encoder layer, an output of the residual network block of the respective encoder layer; and
adaptively recalibrating, based on the received output of the residual network block of the respective encoder layer, the multi-scale feature maps.

4. The method of claim 1, wherein each encoder layer further comprising:
receiving, by a dilated convolution of the respective encoder layer, an output of the SE block of the respective encoder layer;
increasing, by the dilated convolution of the respective encoder layer, receptive fields of multi-scale feature maps without losing spatial resolution;
receiving, by a rectified linear unit (ReLU) activation function of the respective encoder layer, an output of the dilated convolution of the respective encoder layer;
introducing, by the ReLU activation function of the respective encoder layer, non-linearity;
receiving, by a batch normalization (BN) of the respective encoder layer, an output of the ReLU activation function of the respective encoder layer; and
normalizing, by the BN of the respective encoder layer, an output of the ReLU activation function of the respective encoder layer.

5. The method of claim 1, wherein the trained machine learning model further comprises:
a bottleneck disposed between the encoder and a decoder of the machine learning model, wherein the bottleneck comprises:
receiving, by a first gated recurrent unit (GRU) layer, an output of the encoder;
performing, by the first GRU layer, a first non-linear transformation;
receiving, by a second GRU layer, an output of the first GRU layer; and
performing, by the second GRU layer, a second non-linear transformation.

6. The method of claim 5, wherein the first GRU layer and the second GRU layer is a uni-directional GRU layer.

7. The method of claim 1, wherein the trained machine learning model further comprises:
a decoder, wherein the decoder comprises a decoder of encoder layers; and
a plurality of skip connections, wherein each skip connection connects a decoder layer of the decoder layers to an encoder layer of the encoder.

8. The method of claim 1, wherein the first speech waveform is substantially equivalent to a second speech waveform including at least one of: a convolutive room impulse response (RIR) and additive background noise.

9. A non-transitory computer-readable medium comprising instructions that, responsive to execution by a processing device, cause the processing device to perform operations comprising:
receiving a plurality of speech waveform pairs, wherein each speech waveform pair of the plurality of speech waveform pairs includes a first speech waveform and a second speech waveform;
training a machine learning model to generate a third speech waveform based on a first speech waveform of a respective speech waveform, wherein training the machine learning model comprises:
inputting, into the machine learning model, the first speech waveform of the respective speech waveform;
predicting, based on the inputted first speech waveform, the third speech waveform;
inputting, into a loss function, a second speech waveform of the respective speech waveform and a third speech waveform;
optimizing, based on a result of the loss function, the machine learning model, wherein the result of the loss function is calculated based on (i) a difference between the second speech waveform of the respective speech waveform and the third speech waveform and (ii) a difference between a magnitude spectrogram of the second speech waveform of the respective speech waveform and a magnitude spectrogram of the third speech waveform.

10. The non-transitory computer-readable medium of claim 9, wherein the first speech waveform of the respective speech waveform is the second speech waveform of the respective speech waveform including at least one of: a convolutive room impulse response (RIR) and additive background noise.

11. The non-transitory computer-readable medium of claim 9, wherein the machine learning model comprises:
an encoder, wherein the encoder comprises a plurality of encoder layers, each encoder layer comprising:
a residual network block, wherein the residual network block receives one of: the first speech waveform of the respective speech waveform or multi-scale feature maps outputted from a previous encoder layer of the plurality of encoder layers to generate multi-scale feature maps of a respective encoder layer.

12. The non-transitory computer-readable medium of claim 11, wherein the residual network block is a Res2Net.

13. The non-transitory computer-readable medium of claim 11, wherein each encoder layer further comprising:
a squeeze-and-excitation (SE) block, wherein the SE block receives an output of the residual network block of the respective encoder layer and adaptively recalibrates the multi-scale feature maps.

14. The non-transitory computer-readable medium of claim 11, wherein each encoder layer further comprising:
a dilated convolution, wherein the dilated convolution receives an output of the SE block of the respective encoder layer and increases receptive fields of multi-scale feature maps without losing spatial resolution;
a rectified linear unit (ReLU) activation function, wherein the ReLU activation function receives the output of the dilated convolution of the respective encoder layer and introduces non-linearity; and
a batch normalization (BN), wherein BN receives the output of the ReLU activation function of the respective encoder layer and normalizes the output of the ReLU activation function of the respective encoder layer.

15. The non-transitory computer-readable medium of claim 9, wherein the machine learning model further comprises:
a bottleneck disposed between an encoder and a decoder of the machine learning model, wherein the bottleneck comprises:
a first gated recurrent unit (GRU) layer, wherein the GRU layer receives an output of the encoder and performs a first non-linear transformation; and
a second GRU layer, wherein the second GRU layer receives an output of the first GRU layer and performs a second non-linear transformation.

16. A system comprising:
a memory device; and
a processing device coupled to the memory device, wherein the processing device is to perform operations comprising:
receiving, by a speech enhancement system, a first speech waveform;
generating, by an encoder of the speech enhancement system, a latent output of the first speech waveform, wherein each layer of a plurality of encoder layers of the encoder comprises a residual network block and a squeeze-and-excitation (SE) block;
performing, by a bottleneck of the speech enhancement system, non-linear transformation on the latent output of the first speech waveform, wherein the bottleneck comprises a first gated recurrent unit (GRU) layers and a second GRU layer; and
predicting, by a decoder of the speech enhancement system, a second speech waveform from the non-linear transformation of the latent output of the first speech waveform.

17. The system of claim 16, wherein the first speech waveform is substantially equivalent to a second speech waveform including at least one of: a convolutive room impulse response (RIR) and additive background noise.

18. The system of claim 16, wherein generating the latent output of the first speech waveform includes:
for each encoder layer of the plurality of encoder layers, generating, by the residual network block of a respective encoder layer, multi-scale feature maps associated with an input of the respective encoder layer; and
adaptively recalibrating, by the SE block of the respective encoder layer, multi-scale feature maps, wherein an output of the respective encoder layer is a latent output of the input of the respective encoder layer.

19. The system of claim 16, wherein performing, by the bottleneck of the speech enhancement system, non-linear transformation on the latent output of the first speech waveform includes:
receiving latent output of the first speech waveform;
performing, by the first GRU layer, a first non-linear transformation on the latent output of the first speech waveform; and
receiving, by the second GRU layer, an output of the first GRU layer; and
performing, by the second GRU layer, a second non-linear transformation.

20. The system of claim 16, wherein predicting the second speech waveform from the non-linear transformation of the latent output of the first speech waveform includes:
for each decoder layer of a plurality of decoder layers of the decoder, receiving a latent output of an encoder layer of the plurality of encoder layers connected to a respective decoder layer via a skip connection.
